(19) United States
(12) Patent Application Publication
(10) Pub. No.: US 2016/0220442 A1
(43) Pub. Date: Aug. 4, 2016

(54) Reversible massage tool

(71) Applicants: James M. Wittes, Princeton, NJ (US); Glenn R. Halvorsen, Oakhurst, NJ (US)

(72) Inventors: James M. Wittes, Princeton, NJ (US); Glenn R. Halvorsen, Oakhurst, NJ (US)

(21) Appl. No.: 14/544,669

(22) Filed: Feb. 2, 2015

(51) Int. Cl. A61H 39/04; A61H 1/00; A61H 15/00

(52) U.S. Cl. CPC A61H 39/04; A61H 15/00; A61H 1/008; A61H 2015/005

(57) ABSTRACT

A reversible massage tool which has two opposing massage surfaces formed on opposite sides of a frame. A hard massage surface is provided by a plurality of acupressure massage bumps in sets of two each the height of each pair of bumps is lowest at the ends of the tool and increases with each pair towards the center of the tool. This variation in height created a curved massage surface. The bumps are formed above hollow chambers or pockets which may receive a ball such as a tennis ball. Placements of these balls serve to adjust the massage position of the acupressure bumps in height above a surface and in angle and rocking motions. The tool is reversible. If desired, the tennis balls may be employed as a second massage surface by turning the device over so that the massage bumps are now the base surface and the tennis balls are applied to the body. The balls are engaged by friction fit in the hollow chambers.

### SUMMARY OF THE INVENTION AND DESCRIPTION OF RELATED ART

The present invention relates to a reversible massage tool which has two opposing massage surfaces on opposite sides of a frame. A hard massage surface is provided by a plurality of acupressure massage bumps in sets of two each the height of each pair of bumps is lowest at the ends of the tool and increases with each pair towards the center of the tool. This variation in height created a curved massage surface. The bumps are formed above hollow chambers or pockets which may receive a ball which are compressible balls made from hollow, solid, or foam elastomeric material. The pockets in the preferred embodiment of the invention are configured to provide a friction fit for standard tennis balls. Placement of these balls serve to adjust the massage position of the acupressure bumps in height above a surface and in angle and rocking motions.

The tool is reversible. If desired, the tennis ball pattern may be employed on the users back by turning the device over so that the massage bumps are now the base surface and the tennis balls are applied to the body.

The prior art includes U.S. Pat. No. 2,820,454, Wright; U.S. Pat. No. 4,233,966, Takahashi; U.S. Pat. No. 4,374,519, Stauft; U.S. Pat. No. 4,421,110, DeLisle et al.; U.S. Pat. No. 4,936,294, Chu; U.S. Pat. No. 4,974,582, Johnson; U.S. Pat. No. 5,290,307, Choy; U.S. Pat. No. 5,913,839, Wincek; U.S. Pat. No. 6,921,372, Shin; U.S. Pat. No. 8,512,370, Sorensen; and U.S. Pat. No. 8,888,808, Park.

Wright shows a foot massage pad with a number of acupressure bumps. Takahashi discloses an acupressure device where balls can be placed in holes in a base. Stauft uses four balls connected in a frame. DeLisle has a massage mat with two rows of bumps for the back massage. Chu uses tennis balls as the massage elements mounted in a plastic planar support. Johnson and Choy show acupressure pads. Wincek shows massage balls mounted to a frame. Shin and Park use balls and protrusions for acupressure pads. Sorensen teaches the use of balls in a pillow.

None of the patents show a reversible device where the balls provide a massage surface and when reversed, the bumps on the frame produce different motions using the balls as positioning elements.

The invention is used in the following manner: begin with a short session to permit familiarization with the device. Using the device without the tennis balls inserted is a good way to begin because it is in its lowest position. Use a head pillow if needed when working on the upper back. Place a towel over the bumps if they feel too hard. Use unpressurized tennis balls or used tennis balls in the pockets for a softer feel.

### Positions of Invention

1.) Low Flat—No tennis balls added to the bottom side.
2.) High Flat—insert all 10 tennis balls and use either the soft or hard side.
3.) Low Incline—Add 2 tennis balls into the pockets of one end.
4.) Mid Incline—Add 4 tennis balls into the pocket of one end.
5a.) High Incline—Fill all ten tennis balls in the pockets. Use the tennis ball side up with 1 tennis ball under the bottom end at the first massage bump intersection.
5b.) High Incline to Flat—Move the bottom tennis ball to the second massage bump Intersection and lay back to a flat position for a high stretch.

### Rocking Positions

6.) Gentle Rocking—Insert 6 tennis balls in the bottom center pockets leaving the two end pockets empty on both sides.
7.) Seesaw Rocking—Insert 2 tennis balls in the bottom two center pockets.

### Neck Positions (Long Side Across the Body)

8.) Low Neck—Place 2 tennis balls in the two center bump intersections using a tennis ball on each side of the neck.
9.) High Neck—Insert tennis balls to the bottom side to elevate higher and use the same as the Low Neck.

### Low Back and Glute Position (Long Side of Device Across the Body)

10.) Low Back and Glute Rocking—Insert all 10 tennis balls with the ball side up and rock side to side
11.) Low Back and Glute pressure points—Using the ball side up place 1 or 2 tennis balls in the tennis ball intersections.
Use unpressurized tennis balls or used tennis balls for a softer feel.

### BRIEF DESCRIPTION OF THE DRAWINGS

FIG. 1 is a perspective view of bottom of the massage tool:

FIG. 2 is a perspective view of the top of the massage tool:

FIG. 3 is a is a perspective view of the bottom of the massage tool with several balls inserted in the pockets;

FIG. 4 is a side view of the tool of FIG. 4;

FIG. 5 is a is a bottom view of the tool with two balls in the end pockets;

FIG. 6 is a perspective view of the massage tool with balls placed in a different position; and

FIG. 7 is a bottom view of the massage tool with a pair of balls placed in the central pockets.

### DETAILED DESCRIPTION OF THE INVENTION

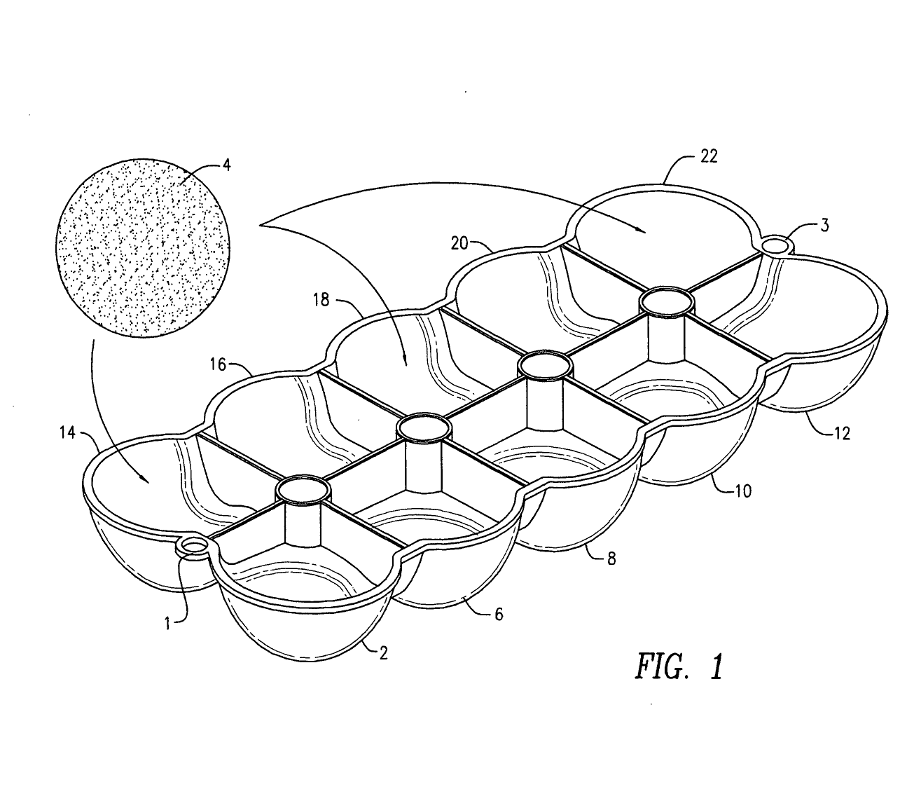

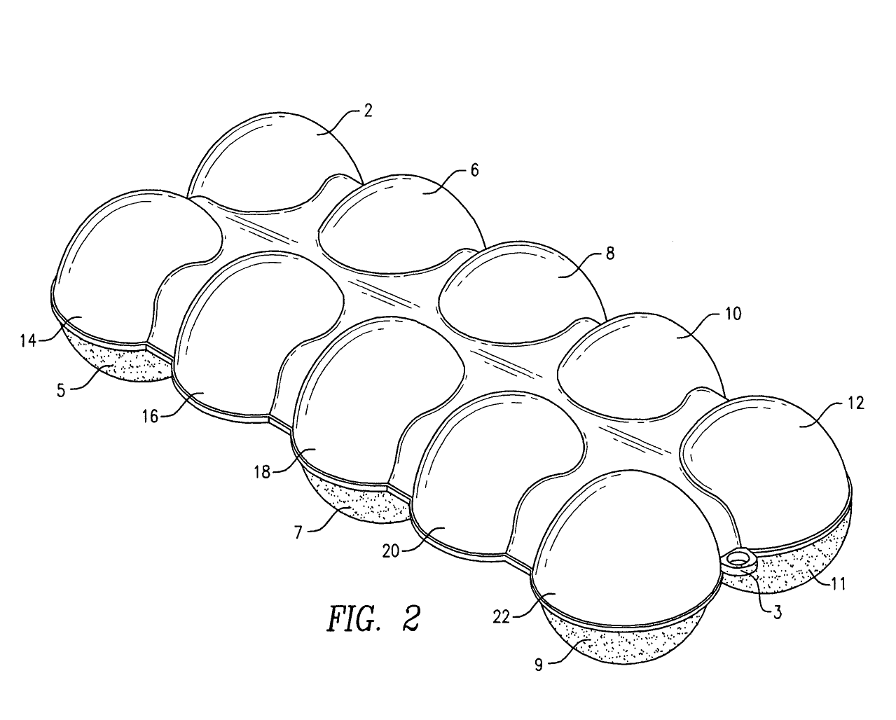

As shown in FIG. 1, the massage tool has a number of acupressure massage bumps, 2, 6, 8, 10, 12, 14, 16, 18, 20 and 22. The bumps are formed with hollow pockets which receive one or more balls shown generally at 4. The balls are held in the pockets by friction fit. Apertures 1 and 3 are formed at the ends of the tool so that it may be hung from a hook when not in use. FIG. 2 is a perspective view of the top of the massage tool. Balls 5, 7, 9 and 11 are shown inserted in the pockets.

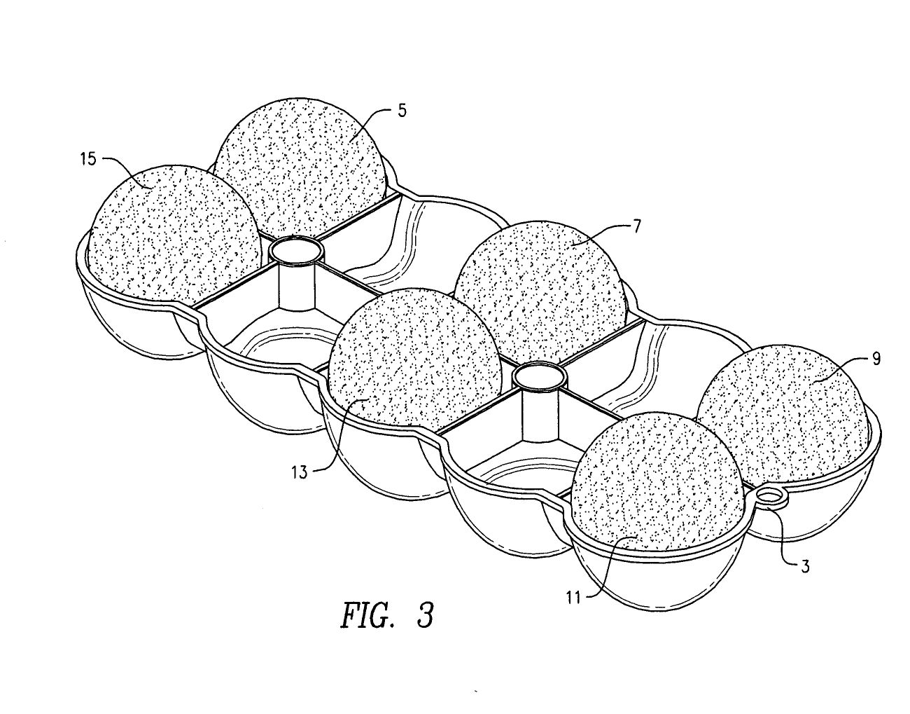

FIG. 3 shows six balls, 5, 7, 9, 11, 13 and 15 inserted in the pockets.

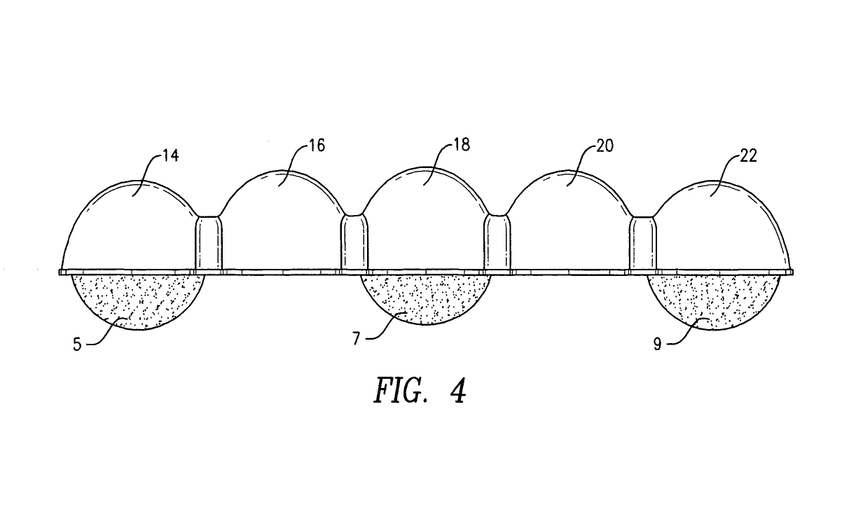

FIG. 4 is a side view of the massage tool. Each pair of massage bumps increase in height from the end of the tool to the center. Massage bumps 14 and 22 are lower than massage bumps 16 and 20. Massage bump 18 at the center of the tool is higher than the other bumps thus creating a curved massage surface at the tops of the bumps.

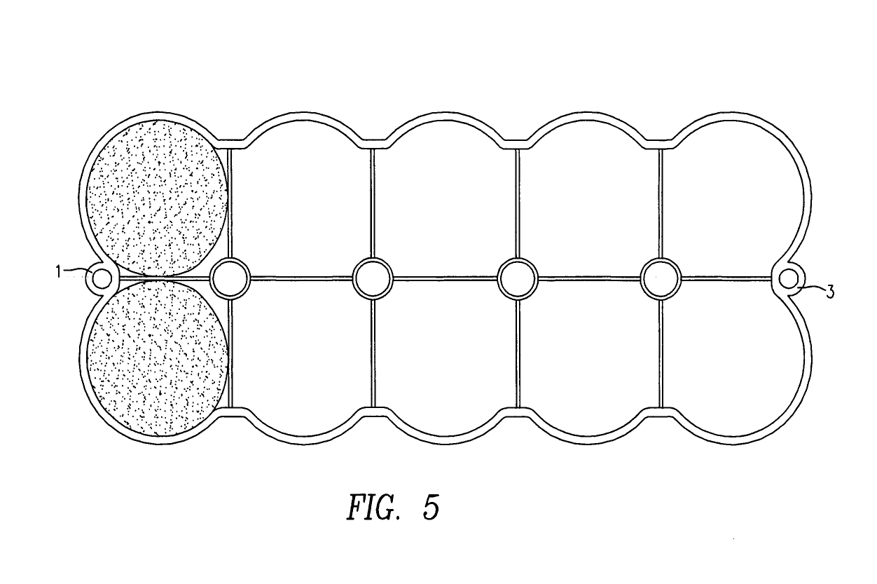

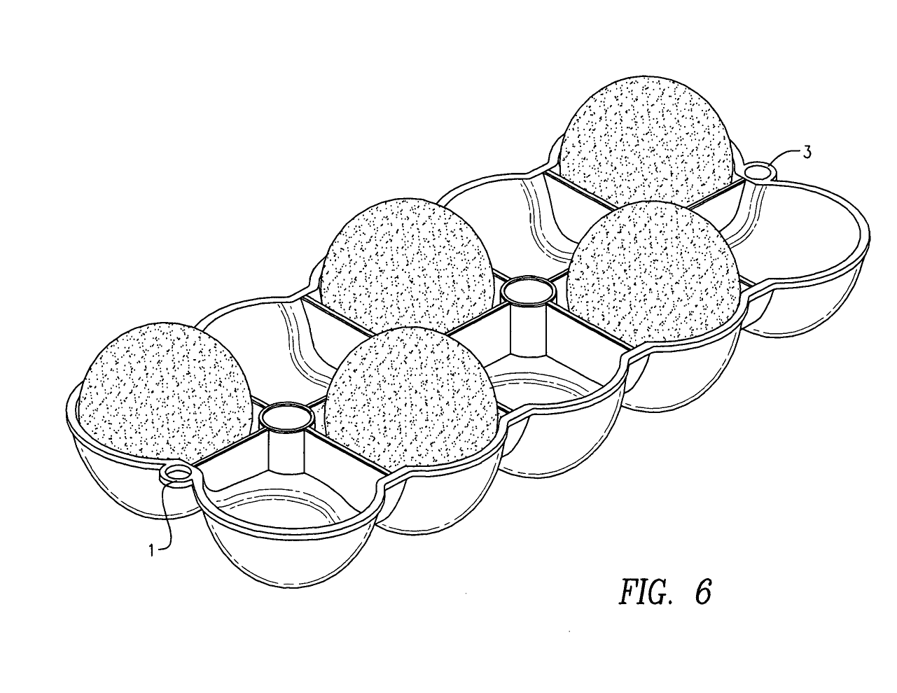

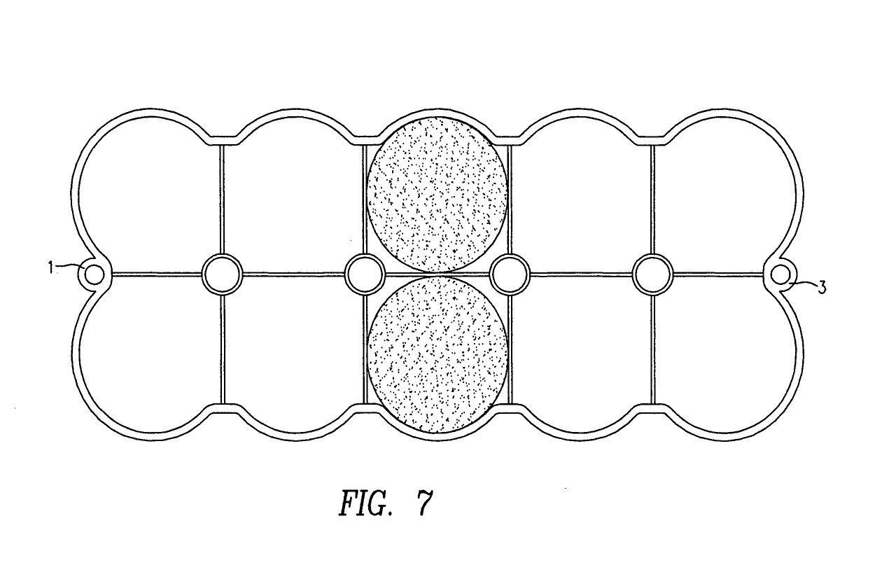

FIGS. 5-7 show various configurations of ball placement in the pockets.

As will now be seen, the acupressure bump surface may be used alone without the balls. Balls may be inserted as desired in different locations to create different positions for the acupressure massage surface. These positions may produce rocking motions, angled positions, and combinations of both rocking and angled positions. When lying on either side of the device, the spine is stretched by gravity.

The balls may also e used as a massage surface by reversing the tool so that the balls contact the body. Placement of balls in desired configurations enable different massage experiences.

Further modifications to the methods and apparatus of the invention may be made without departing from the spirit and scope of the invention.

We claim:

1. A reversible massage tool comprising: a first massage surface formed of a plurality of acupressure bumps; a second massage surface formed of a plurality of balls on the opposite side of said first massage surface.

2. The reversible massage tool of claim 1 wherein each of said acupressure bumps include a pocket formed beneath said bump for receiving said balls therein.

3. The reversible massage tool of claim 1 wherein adjacent acupressure bumps differ in height to create a curved massage surface.

4. The reversible massage tool of claim 2 wherein the location of said balls in said pockets permit said first massage surface to move in a rocking motion.

5. A reversible massage tool comprising: a hard massage surface including a plurality of acupressure massage bumps arranged in pairs; the height of each pair of bumps being lowest at the ends of the massage tool and increasing with each pair of bumps towards the center of the tool to create a curved massage surface; said bumps being formed by hollow chambers for receiving a ball therein; the location of said balls adjusting the massage position of the acupressure bumps in height above a surface and in angular and rocking motions; said balls providing a second soft massage surface by reversing the tool and applying said balls to the body.

6. A reversible massage tool comprising: a first massage surface formed of a plurality of rows of different height acupressure bumps to produce a curved massage surface; a pocket formed beneath each of said acupressure bumps for receiving a ball therein, said balls being mounted in said pockets in a desired configuration, said balls forming a second massage surface.

7. The reversible massage tool of claim 6 wherein said configuration varies the range of motion of said first massage surface.

8. The reversible massage tool of claim 7 wherein said configuration varies the massage effects of said second massage surface.

9. The reversible massage tool of claim 6 wherein said balls are compressible formed from hollow, solid, or foam elastomeric material.

10. The reversible massage tool of claim 9 wherein said pockets are configured to provide a friction fit for said balls.
